(19) United States
(12) Patent Application Publication
(10) Pub. No.: US 2009/0119372 A1
(43) Pub. Date: May 7, 2009

(54) SYSTEM AND METHOD FOR PROVIDING EMAIL WARNINGS

(76) Inventors: Sean Callanan, Dublin (IE); Patrick Joseph O'Sullivan, Dublin (IE); Gary Denner, Kildare (IE); Carol Sue Zimmet, Boxborough, MA (US); Ruthie D. Lyle, Durham, NC (US)

Correspondence Address: HOLLAND & KNIGHT, 10 ST. JAMES AVENUE, BOSTON, MA, 02116-3889, US

(21) Appl. No.: 11/934,472

(22) Filed: Nov. 2, 2007

(51) Int. Cl. G06F 15/82

(52) U.S. Cl. 709/206

(57) ABSTRACT

A system and method for providing an email warning including analyzing one or more communication activities of a user. A pattern of communication activity may be defined based upon, at least in part, the analyzed one or more communication activities of the user. An attempted communication activity may be compared to the pattern of communication activity. A notification may be provided to the user if the attempted communication activity is inconsistent with the pattern of communication activity.

### TECHNICAL FIELD

This disclosure relates to communications applications, and more particularly to a warning system for email communications.

### BACKGROUND

In the present internet and electronic communication age, email is an increasingly dominant means of communication, especially mass communication, because it allows the same message to be easily sent to a large group of people. Unfortunately, while intending only to respond to the original sender of a mass emailing, people often “reply to all” on emails that have numerous recipients, rather than only replying to the sender. Sometimes such a universal response is intentional because the user knows all of the mass email recipients, and intends the response to the sent to each of the mass email recipients. Other times such a universal response is unintentional (e.g., due to inadvertently selecting the “reply to all” option rather than simply the “reply” option in the email user interface). An unintentional universal response can result in an embarrassing situation. Thus, there exists a need for an email warning system that will notify the user when he has chosen to reply to an email outside of his usual pattern of communication.

### SUMMARY OF THE DISCLOSURE

In a first implementation, a method includes analyzing one or more communication activities of a user. A pattern of communication activity is defined based upon, at least in part, the analyzed one or more communication activities of the user. An attempted communication activity is compared to the pattern of communication activity. A notification is provided to the user if the attempted communication activity is inconsistent with the pattern of communication activity.

One or more of the following features may be included. The one or more communication activities may include one or more of email, instant messaging, and voice communication. The pattern of communication activity may be updated based upon, at least in part, a user response to the notification.

The attempted communication activity may include a reply to all for an email. The attempted communication activity may include a reply to an email in which at least one recipient is outside of an organizational group of the user. The attempted communication activity may include a reply to an email in which at least one recipient is an external user. The attempted communication activity may include a reply to an email from a group for which the user is not a member. The attempted communication activity may also include an email having at least one recipient outside of a predetermined range in an organization hierarchal structure.

A notification policy may be defined based upon, at least in part, the pattern of communication activity, the notification policy may further include one or more user specified criteria for providing the notification. The notification policy may further include a user defined maximum number of recipients, the method may further include providing the notification when the user attempted communication includes more than maximum number of recipients.

According to another implementation, a computer program product may reside on a computer readable medium, which may have a plurality of instructions stored thereon. When executed by a processor, the instructions cause the processor to perform operations including analyzing one or more communication activities of a user. The instructions further cause the processor to define a pattern of communication activity based upon, at least in part, the analyzed one or more communication activities of the user. An attempted communication activity is compared to the pattern of communication activity. The instructions further cause the processor to provide a notification to the user if the attempted communication activity is inconsistent with the pattern of communication activity.

One or more of the following features may be included. The one or more communication activities may include one or more of email, instant messaging, and voice communication. The instructions may further cause the processor to update the pattern of communication activity based upon, at least in part, a user response to the notification.

The attempted communication activity may include a reply to all for an email. The attempted communication activity may include a reply to an email in which at least one recipient is outside of an organizational group of the user. The attempted communication activity may include a reply to an email in which at least one recipient is an external user. The attempted communication activity may include a reply to an email from a group for which the user is not a member. The attempted communication activity may also includes an email having at least one recipient outside of a predetermined range in an organization hierarchal structure.

The instructions may further cause the processor to define a notification policy based upon, at least in part, the pattern of communication activity, the notification policy may further include one or more user specified criteria for providing the notification. The notification policy may further include a user defined maximum number of recipients, the method may further include providing the notification when the user attempted communication includes more than maximum number of recipients.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an email warning process coupled to a distributed computing network.

FIG. 2 is a flowchart of a process executed by the email warning process of FIG. 1.

FIG. 3 is a diagrammatic view of an email warning provided by the email warning process of FIG. 1.

### DETAILED DESCRIPTION

### System Overview

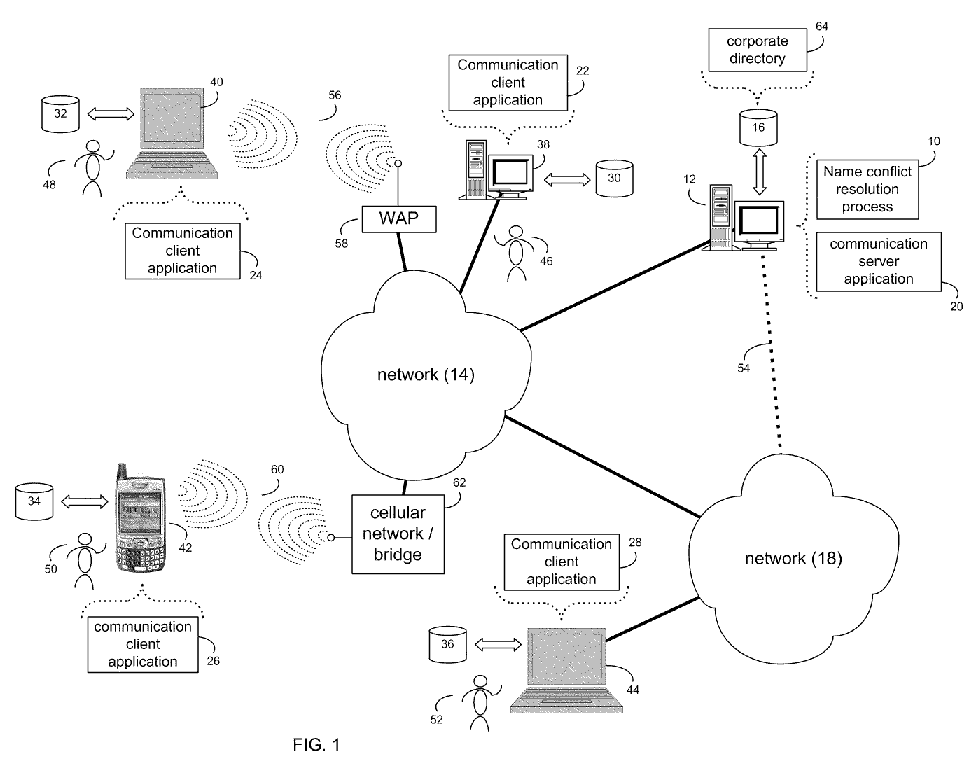

Referring to FIG. 1, there is shown email warning process 10 that may reside on and may be executed by server computer 12, which may be connected to network 14 (e.g., the internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, email warning process 10 may reside on a client electronic device, such as a personal computer, notebook computer, personal digital assistant, or the like.

As will be discussed below in greater detail, email warning process 10 may enable a user to avoid replying to unintended email recipients by providing a warning when the user attempts to communicate outside a usual pattern of communication. To accomplish this, email warning process 10 may analyze communication activity of a user, and define a pattern of communication. Email warning process may compare an attempted communication to the communication pattern and provide a notification if the attempted communication is inconsistent with the communication pattern.

Email warning process 10 may analyze one or more communication activities of a user including, but not limited to, the user's email communications, instant messaging chats, and voice communications, for example. The analysis may include referencing a corporate directory to determine whether potential communication recipients work within the same company, group, division, or list serve as the user.

The instruction sets and subroutines of email warning process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more communication server applications (e.g., communication server application 20), examples of which may include but are not limited to email server applications that may include calendar and/or scheduling modules or components (e.g., Lotus Domino™ Server and Microsoft Exchange™ Server), instant messaging server applications (e.g., IBM Lotus Sametime™, Microsoft Office Live Communications Server™, Jabber XCP™, and AOL Instant Messenger™), voice over IP server applications or PBX telephone systems. Communication server application 20 may interact with communication client applications 22, 24, 26, 28, examples of which may include, but are not limited to, email client applications that may include calendar and/or scheduling modules (e.g., Lotus Notes™ and Microsoft Outlook™), instant messaging client applications (e.g., AOL Instant Messenger™, IBM Lotus Sametime™, Google Talk™), voice over IP client applications, and softphone applications. Email warning process 10 may be a stand alone application that interfaces with communication server application 20 or may be an applet/application that is executed within communication server application 20.

The instruction sets and subroutines of communication server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the email warning process 10 may be a client-side application (not shown) residing on one or more client electronic device 38, 40, 42, 44 (e.g., stored on storage device 30, 32,34,36, respectively). As such, the email warning process 10 may be a stand alone application that interfaces with a communication client application (e.g., communication client applications 22, 24, 26, 28), or may be an applet/application that is executed within a communication client application. As such, the email warning process 10 may be a client-side process, a server-side process, or a hybrid client-side/server-side process, which may be executed, in whole or in part, by server computer 12, or one or more of client electronic device 38, 40, 42, 44.

The instruction sets and subroutines of communication client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using communication client applications 22, 24, 26, 28, users 46, 48, 50, 52 may engage in communication activities (e.g., send/receive email communications, conduct instant messaging chats, schedule calendar events, conduct telephone conversations, and similar activities). Engaging in communication activities may include accessing communication server application 20.

Users 46, 48, 50, 52 may access communication server application 20 directly through the device on which the communication client application (e.g., communication client applications 22, 24, 26, 28) is executed, namely client electronic devices 38, 40, 42, 44, for example. Users 46, 48, 50, 52 may access communication server application 20 directly through network 14 or through secondary network 18. Further, server computer 12 (i.e., the computer that executes communication server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

### Email Warning Process

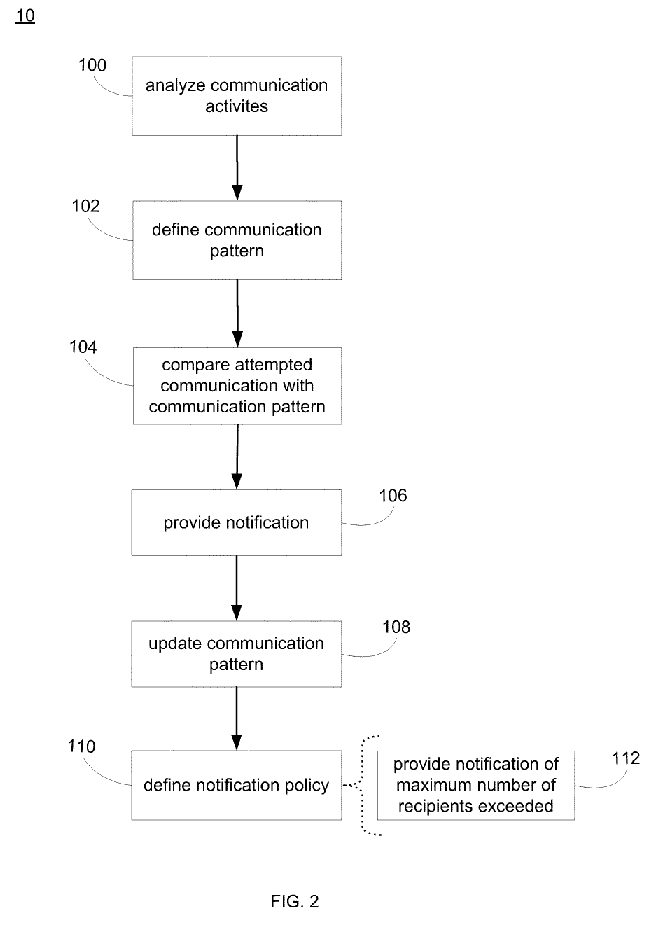

Referring also to FIG. 2, email warning process 10 may analyze 100 one or more communication activities of a user (e.g., user 46, 48, 50, 52). Email warning process 10 may define 102 a pattern of communication activity based upon, at least in part, the analyzed 100 one or more communication activities of the user. Email warning process may compare 104 an attempted communication by the user with the defined 102 pattern of communication activity. Email warning process 10 may also provide 106 a notification to the user if the attempted communication activity is inconsistent with the pattern of communication activity.

The communication activities of the user may be conducted using one or more client electronic device (e.g., client electronic devices 38, 40, 42, 44, for example) and/or may involve interaction with server computer 12. For example, user 46 may conduct a plurality of communication activities, such as one or more of email, instant messaging, and voice communication, for example. In part, user 46's communication activities may be conducted with people with whom the user has a relationship (e.g., one or more of users 48, 50, 52), as indicated by originated and/or received email, instant messaging, and voice communications from one or more of users 48, 50, 52, as discussed above. Also, user 46's communication activities may be conducted with people with whom user 46 works, e.g., based upon, at least in part, a corporate, or similar, directory (e.g., corporate directory 64 stored on storage device 16 associated with server computer 12). Associations by department, work group, and the like may be indicated in corporate directory 64, also as discussed above. Additionally, user 46's communication activities may involve membership in groups and list serves for which mass communication is utilized.

Email warning process 10 may define 102 a pattern of communication activity based upon, at least in part, the analyzed 100 one or more communication activities of the user. Email warning process 10 may analyze 100 the user's communication activities and habits and may define 102 a pattern based upon, at least in part, such communication activities. For example, user 46 may always reply to all when replying to an email from a particular distribution list (e.g., including users 48 and 50). In another example, user 46 may remove a particular recipient (e.g., user 52, who may be one of user 46's superiors), when replying to all in an email directed to user 46's whole working group (e.g., which may include users 48, 50, and 52). By analyzing 100 user 46's communication activities, email warning process 10 may detect such user habits and define 102 a pattern of communication activity accordingly.

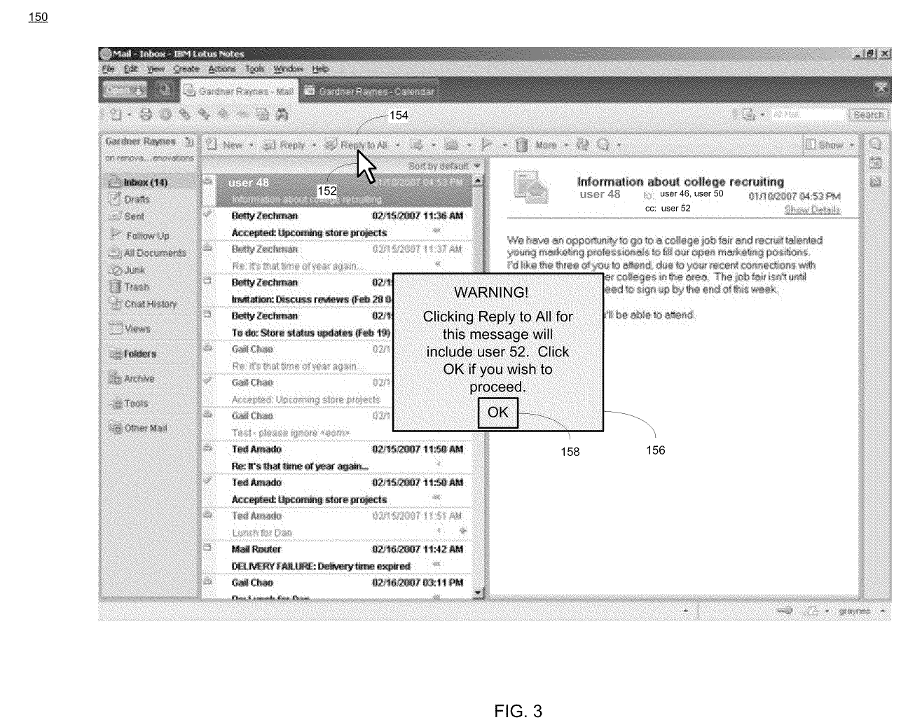

Email warning process 10 may compare an attempted communication activity to the defined 102 pattern of communication activity for the user. In one example, the attempted communication activity may include a reply to all for an email. Continuing with the above-stated example, and referring also to FIG. 3, user 46 may receive a group email including users 46, 48, 50, and 52 as recipients, shown in email user interface 150. User 46 may select (e.g., using onscreen pointer 152 controlled by a pointing device, such as a mouse; not shown) “reply to all” 154 in email user interface 150. Email warning process 10 may compare 104 the attempted communication activity (e.g., reply to all for an email including users 48, 50, and 52 as recipients) to the pattern of communication activity defined 102 for user 46. Continuing with the above examples in which user 46 routinely removes user 52 from a reply to all email directed to user 46's working group. As such, the attempted communication activity (i.e., reply to all for an email including users 48, 50, and 52) may be contrary to the pattern of communication activity defined 102 for user 46.

Continuing with the above-stated example, having determined that the attempted communication activity is inconsistent with the pattern of communication activity defined 102 for user 46, email warning process 10 and/or communication client application 22 may provide 106 a notification to user 46. For example, email warning process 10 and/or communication client application 22 may render notification 156, alerting user 46 that “clicking reply to all will include user 52”. As such, email warning process 10 may provide 106 a notification to user 46 that the attempted communication activity is inconsistent with the pattern of communication activity defined 102 for user 46.

Email warning process 10 may update 108 the pattern of communication activity based upon, at least in part, the user response to the notification. Continuing with the above example, notification 156 may provide user 46 with the option of continuing with the attempted communication activity (e.g., by clicking “ok” 158 to proceed with sending a “reply to all” email including user 52 as a recipient). If user 46 proceeds with the attempted communication activity (e.g., by clicking “ok” 158), email warning process 10 may update 108 the pattern of communication defined 102 for user 46. In the above-stated example, updating 108 the pattern of communication defined 102 for user 46 may reflect that user 46's communication activities may have changed (e.g., to include reply to all in emails including user 52 as a recipient). Email warning process 10 may update 108 the pattern of communication activity immediately upon a change in user 46's communication activity. Alternatively, email warning process 10 may continue to provide 106 a notification of the same attempted inconsistent communication activity (e.g., replying to all for an email including user 52 as a recipient) for several more such attempted communications (e.g., for a predetermined number of similar attempts) until it is likely that user 46 has in fact changed his pattern of communication activity (i.e., the incident of sending a reply to all including user 52 was not an isolated event). Further, as a condition to updating 108 the pattern of communication activity, email warning process 10 may verify that the perceived change in user 46's communication patterns (e.g., based upon analyzed 100 communication activities) are intentional. For example, email warning process 10 prompt user 46 t affirmatively accept the change in communication patterns before updating 108 the pattern of communication activities.

Email warning process 10 may define 110 a notification policy that may be based upon, at least in part, the pattern of communication activity, as well as one or more specified (e.g., user specified or specified by a third party, such as a system administrator) criteria for providing 106 the notification. For example, email warning process 10 may allow the notification policy to be defined 110 to include criteria for providing 106 a warning for all instances of an attempted reply to all. Similarly, the notification policy may be defined to include criteria for providing 106 a warning for all originating email (e.g., user created email), reply email, reply to all email, and /or forward email including recipients outside of the user's work group or organization, exceeding a maximum number of recipients, as well as various other criteria. For example, email warning process may provide 112 a notification that the maximum number of recipients has been exceeded. As noted above, the email notification policy may apply to attempted communication activities other than reply to all, e.g., forwarding, reply to, emails including specific recipients, as well as to communication channels other that email (e.g., instant messaging, text messaging, and the like).

For example, in addition/as an alternative to a reply to all for an email including a specific recipient, the attempted communication activity may include any reply to all for an email. As described above, a user may generally not wish to reply to all recipients in a distribution list or group email, but may do so accidentally or out of habit. Email warning process 10 may be configured to provide 106 a notification any time the user attempts to reply to all.

Similarly, the attempted communication activity may include a reply to an email in which at least one recipient is outside of an organizational group of the user. For example, a user may receive an email which includes members of his organizational group, as well as other recipients. Email warning process 10 may provide 106 a notification if the attempted communication activity includes a reply to all and at least one of the recipients is outside of the user's organizational group. For example, email warning process 10 may compare recipient names or email addresses of the recipients of a reply to all email to an organizational structure (e.g., defined in corporate directory 64) to determine whether a recipients is outside of the user's organizational group.

Further, email warning process 10 may define 110 a notification policy that may be based upon, at least in part, one or more specified criteria for providing 106 the notification. In response to an attempted communication activity (e.g., an original email, a reply, and/or forward email) in which at least one recipient of the communication is outside of the user's location (e.g., geographic region, organization, department, or the like). This aspect may be facilitated in connection with a system in which the user's location may be expressed as an attribute of the user's directory entry.

In a related example, the attempted communication activity may include an email (e.g., an original email, a reply or reply to all email, and/or a forward email) including at least one recipient outside of a predetermined range in an organization hierarchal structure (e.g., as may be defined in corporate directory 64). For example, user 46 may be a manager overseeing one or more subordinates. Further, user 46 may have one or more peers at the same management level, and may also be subordinate to one or more other senior managers. User 46 may attempt to reply to all for an email including subordinates, peers and senior managers. Email warning process 10 may provide 106 a notification that the attempted communication includes as recipients subordinates, senior managers, and/or a mixture of subordinates, peers, and senior managers. The range on the organization hierarchal structure for which email warning process 10 may provide 106 a warning may be configurable. For example, no warning may be provided for emails including as recipients immediate subordinates, but may provide 106 a warning for emails including as recipients subordinates two tiers below the user in the organization hierarchal structure. Similar configurations may be applied for recipients above the user in the organization hierarchal structure.

In a similar manner, the attempted communication activity may include an original email, a reply to an email, or a forwarded email (or various other communication activities) in which at least one recipient is an external user. For example, a user may receive an email which includes members of his organization, as well as other recipients (e.g., that do not work for the user's company). Email warning process 10 may provide 106 a notification if the attempted communication includes reply to all and at least one of the recipients is outside of the user's organization. As with the preceding Email warning process 10 may compare recipient names or email addresses to corporate directory 64 to determine whether a recipients is outside of the user's organization.

Furthermore, the attempted communication activity may include a reply to an email from a group for which the user is not a member. For example, a user may receive an email from a group or organization to which the user is not a member. Email warning process 10 may provide 106 a notification if the attempted communication activity includes a reply to all for the email from the group that the user is not a member of. Email warning process 10 may compare the intended group recipient to a list of the groups of which the user is a member. As with the preceding examples, email warning process may provide 106 a notification based upon if the intended group recipient is not a group of which the user is a member.

In a related manner, providing 106 a notification may include providing a notification to a third party. For example, a new employee (i.e., a communication user) may not be fully initiated into a company's communication policies. The new employee may generally be allowed to conduct communication activities without restraint. In the event that an attempted communication activity of the new employee is inconsistent with a defined 102 pattern of communication activity and/or a defined 110 notification policy, email warning process 10 may provide 106 a notification to a third party, e.g., the new employees supervisor, an administrator, or the like, e.g., providing the third party with the opportunity to review or prevent the attempted communication activity of the new employee.

While many of the above-described aspects, such as defining 110 the notification policy based upon, at least in part, one or more specified criteria for providing 106 a notification, have been described in terms of being specific to a given user, it should be appreciated that such features, (e.g., specified criteria for providing 106 the notification) may be implemented across a communication system. For example, an email warning process 10 may define 110 a notification policy to be applied system-wide for all, or at least a portion of, the communication users of the system. As such, the organization may define 110 a notification policy for providing 106 a notification related to any communication activity of any user that is outside accepted communication activities of the organization.

A number of implementations have been described. Nevertheless, it will be understood that various modifications may be made. Accordingly, other implementations are within the scope of the following claims.

What is claimed is:

1. A method comprising:
analyzing one or more communication activities of a user;
defining a pattern of communication activity based upon, at least in part, the analyzed one or more communication activities of the user;
comparing an attempted communication activity to the pattern of communication activity; and
providing a notification to the user if the attempted communication activity is inconsistent with the pattern of communication activity.

2. The method of claim 1, wherein the one or more communication activities includes one or more of email, instant messaging, and voice communication.

3. The method of claim 1, further including updating the pattern of communication activity based upon, at least in part, a user response to notification.

4. The method of claim 1, wherein the attempted communication activity includes a reply to all for an email.

5. The method of claim 1, wherein the attempted communication activity includes a reply to an email in which at least one recipient is outside of an organizational group of the user.

6. The method of claim 1, wherein the attempted communication activity includes a reply to an email in which at least one recipient is an external user.

7. The method of claim 1, wherein the attempted communication activity includes a reply to an email from a group for which the user is not a member.

8. The method of claim 1, further including defining a notification policy based upon, at least in part, the pattern of communication activity, the notification policy further including one or more user specified criteria for providing the notification.

9. The method of claim 8, wherein the notification policy further includes a user defined maximum number of recipients, the method further including providing the notification when the user attempted communication includes more than maximum number of recipients.

10. The method of claim 1, wherein the attempted communication activity includes an email having at least one recipient outside of a predetermined range in an organization hierarchal structure.

11. A computer program product residing on a computer readable medium having a plurality of instructions stored thereon which, when executed by a processor, cause the processor to perform operations comprising:
analyzing one or more communication activities of a user;
defining a pattern of communication activity based upon, at least in part, the analyzed one or more communication activities of the user;
comparing an attempted communication activity to the pattern of communication activity; and
providing a notification to the user if the attempted communication activity is inconsistent with the pattern of communication activity.

12. The computer program product of claim 11, wherein the one or more communication activities includes one or more of email, instant messaging, and voice communication.

13. The computer program product of claim 11, further including updating the pattern of communication activity based upon, at least in part, a user response to notification.

14. The computer program product of claim 11, wherein the attempted communication activity includes a reply to all for an email.

15. They computer program product of claim 11, wherein the attempted communication activity includes a reply to an email in which at least one recipient is outside of an organizational group of the user.

16. The computer program product of claim 11, wherein the attempted communication activity includes a reply to an email in which at least one recipient is an external user.

17. The computer program product of claim 11, wherein the attempted communication activity includes a reply to an email from a group for which the user is not a member.

18. The computer program product of claim 11, further including defining a notification policy based upon, at least in part, the pattern of communication activity, the notification policy further including one or more user specified criteria for providing the notification.

19. The computer program product of claim 18, wherein the notification policy further includes a user defined maximum number of recipients, the method further including providing the notification when the user attempted communication includes more than maximum number of recipients.

20. The computer program product of claim 11, wherein the attempted communication activity includes an email having at least one recipient outside of a predetermined range in an organization hierarchal structure.
